(19) United States
(12) Patent Application Publication
(10) Pub. No.: US 2011/0258927 A1
(43) Pub. Date: Oct. 27, 2011

(54) Garden waterbed

(76) Inventors: Richard C. Carter, Ten Sleep, WY (US); Jayne Andrea Carter Cabre, Ten Sleep, WY (US)

(21) Appl. No.: 12/799,420

(22) Filed: Apr. 23, 2010

(51) Int. Cl. A01G 13/00; A01G 9/02

(52) U.S. Cl. 47/66.7; 47/86

(57) ABSTRACT

The Garden Waterbed is constructed of a durable tube of flexible UV protected material. The ends of the tube have been sealed, enabling it to hold water. Circular holes have been cut out and sealed down the center length of the tube, at regular intervals. A valve is installed at one end of the tube, allowing water to be filled into the large single chamber and hold it with a tight seal. There are multiple purposes of the Garden Waterbed. The water bed's intended use is; to be rolled out in a agriculture environment or garden area, to be filled with water, and to have plants buried in the soil within the growth units. The surrounding water increases the thermal mass surrounding the plants in the circular holes. The thermal mass absorbs the suns energy and increases soil temperature, thus increasing the growing season and boosting production. The opaque plastic stops sunlight from reaching the ground and eliminates weeds and undesirables from competing with your crop. At the same time insulating the ground and shading the soil, decreasing crop water consumption and increasing earthworm populations, increasing overall cleanliness of the subject grown, and increasing disease and insect infestation protection. The flexible design allows for quick and easy installation and roll away storage.

### BACKGROUND OF THE INVENTION

1. Field of Invention

The present invention is in the field of devices for gardening and agriculture. More particularly in the field of self supporting thermal protection and suppression of competitive vegetation.

2. Description of Related Art

Weed Suppression

Plastics, fabrics, and landscape cloths have been used, in prior art, to aid in the control of weeds and stabilize tilled soils. When used in fields or garden environments, these devices greatly reduce maintenance otherwise required to prevent overgrowth of weeds. Since these devices are simply laid on ground, they are highly prone to dislocation by wind, heavy rain, and animals. This dislocation typically exposes underlying soil, permitting weeds to germinate and grow. Sometimes gardeners attempt to hold down the device by placing soil or rocks on the outer edges of the device. This adds obstructions to the environment where laborers are working. Extreme rains and winds can still dislodge these objects from the outer edges. Some have sought to solve this problem by using stakes to hold down the device. This method is quite labor intensive. It requires the stake be pushed through fabric and into the soil. This action makes holes and tears in the protective device. Over time these holes and tears enlarge, allowing sunlight to penetrate underneath the device, promoting further weed growth and further tearing. These devices are not only time consuming to deploy, but typically can only be used once and are difficult to remove.

Dislocation of prior art devices is typically restricted through stakes of staples pushed through the material of the prior art to hold it to the soil. This is imperative with the use of prior art to prevent dislocation, though laborious to install and remove. Dislocation by wind of unsecured prior art occurs in two areas. First, wind may lift the outer edges of the fabric or cloth, causing the edges to fold back, bunch, or lifting the entire device. Second, wind may enter the planting spaces and cause the device to lift up and shift position. An advantage of the present invention is that the entire surface, of the device, is in pressured contact with the soil. The weight of the water within the device holds the present invention in close contact with the soil, eliminating any wind penetration and need for stakes, staples, or any additional weighted devices.

Thermal Protection

Members of the plant kingdom are sensitive to the environments in which they are grown. Members of this group include; woody and herbaceous, biennial, annual, and perennial plants whose flowers, bulbs, fruit, leaves, roots, stems, and tubers are used as food or for ornamental purposes. It is known that elongating the growing season for plants and crops will provide an opportunity to increase yields. Various devices have been used to protect plants and crops during their initial stages of growth in the early spring, or from harsh temperatures and frost in the autumn. Some start their seedlings in a greenhouse, thus controlling the environment and protecting the plant from harsh environmental conditions until late spring. Considerably adding to the end cost of the plant/crop, produce, fruit, or blossoms. Efforts to combat the colder conditions have been made by covering the plant with burlap, straw, or leaves in anticipation of a frost or snow. The global competition of produce markets makes it essential to maximize the productivity of each individual plant which is grown, and to increase the duration of the growing season, despite adverse climatic conditions. Still others have patents suggesting the use of thermally protective devices with plural fluid filled compartments. (U.S. Pat. No. 4,821,453 James B. Morehead April 1989) (Brittain U.S. Pat. No. 4,267,665 Wollace et al May 1981)

A difficulty has been observed with the inventions of the type suggested by the present invention in that the use of numerous devices need to be procured to support numerous plants. Essentially, each of the aforementioned inventions will only provide ample growing space for a single plant or crop. Increasing the number of devices raises the amount of labor involved with initial implementation, maintenance, and removal. Single plant devices also increase the amount of overhead.

U.S. Pat. No. 4,071,974 Tripp February 1978 offers an attempt to protect multiple numbers of plants from frost by harnessing thermal energy gained from the placement of a water filled sleeve next to plants. It offers thermal protection by covering the soil adjacent to growing plants. The use of one of these devices would offer thermal protection to only one side of the plant. Two devices, placed both adjacent and parallel to the plant are shown in prior art. This design limits the degree of thermal protection to just two sides of the plant, leaving the plant unprotected on two sides.

The aforementioned device would require multiple devices to offer limited thermal protection to each row of plants. The strip between the two devices, where the plants are rooted, is open and vulnerable to frost. The open gap between the two devices also allows an avenue for weeds and competitive plants to grow, offering no protection from competitive species where they are intrinsically most vulnerable, close to the roots and base. The previous art offers the use of multiple devices for protection of a single row of plants, multiple devices increases costs and takes up and inadequate amounts of space, making the garden plot cumbersome and inadequate for workers to tend to the plants. The positioning the device adjacent to the plants, yet close enough to gain the benefit of the thermal energy, takes up the space essential for workers to freely move through the rows to tend to the plants.

Another limitation of this art is that the design will not work on slopes or steep ground. The design of the sleeve of comprising the thermal energy is not suitable for use on any sort of a slope. The device would be inadequate if the apparatus was placed horizontal to the slope of the gradient, following the contour. Once fluid capacity is reached, gravity would force the mass down hill. The fluid contained in the sleeve would act as a wheel and roll. The device would not be adequate if the apparatus was placed vertical to the slope of the gradient. While filling the apparatus, the lower portion of the device would experience tremendous pressure from the fluid higher up the gradient, while the uphill portion would have little thermal retaining mass. In either case the thermal mass would be inconsistent and not uniform. This device is not designed for use on a slope or hill and would typically tear of the end would come undone and release the thermal mass.

While there are many advantages set forth by utilizing water contained in a sleeve to offer thermal protection to plants, the present invention has novel improvements on a number of limitations by U.S. Pat. No. 4,071,974.

### BRIEF SUMMARY OF THE INVENTION

The present invention provides a self-supporting, thermally protective semi-enclosed weed barrier that enhances plant and crop growth. Formed of a single flexible tube, this device suppresses weed growth while simultaneously protecting multiple plants from adverse environmental factors including: wind, cold, and frost.

The present invention is directed to a plant/crop protective enclosure which comprises a single hollow tube. The opposing sides of the tube have been sealed creating a capsule capable of holding a quantity of fluid within, A valve is present on the capsule to facilitate the filling and draining of fluid from the capsule. Multiple holes have been created along the length of the capsule, these will be referred to as “growth units”. The outer perimeter of the growth units have been sealed to preserve the integrity of the capsule. The growth units create a tangible area to access the underlying soil through the protective capsule. The growth units allow for crops and plants to be placed in the soil. The encompassing fluid filled body of the present invention utilizes thermal mass to absorb thermal energy during exposure to sunlight and release that thermal energy when the temperature of the air is colder than that of the average thermal mass held by the present invention.

The underlying body of the capsule will expand in all horizontal planes from the growth units, a distance further than the underground growth radius of the plants/crops within. The fluid mass of the capsule will hold the comprising material tight to the ground. This creates an impermeable weed bather surrounding the growth unit. This weed barrier is held down by it's own mass, resisting wind and inadvertent dislocation, without the aid of other devices.

The current invention is thermally insulated and creates a close seal with the soil it covers, therefore inhibiting surface evaporation, it greatly reduces the volume of water required to maintain healthy productive plants. Also reducing watering intervals and the labor required to implement. This is particularly beneficial in areas of drought or where water usage is restricted. This device restricts weed growth, therefor it is particularly beneficial to organic gardeners of farmers, because no herbicides are required. Plant disease and spoilage is greatly reduced without the use of antimicrobial agents and insecticides since the device blocks soil particules from splashing upward and onto leaves or fruit during rains or watering. A known source of disease organisms and promoter of insect infestation. Since the use of this present invention minimizes crop contact with the soil, fruits and vegetables remain clean and may be harvested and stored without cleaning.

Because the construction of the present invention is UV-resistant, the device may be left in place year round. After produce has been harvested, the plant growth within the provided growth units may be pulled and disposed of. The soil can be turned by hand prior to replanting. Sub-soil plant growth can also be left to decompose during the non-growing season.

The use of the present invention is designed to be used on slopes or hills. The use of sealed ends prevents premature release of thermal mass from higher pressures created by gravity's effect on the fluid filled mass on the uphill portion of the apparatus. The seal around the growth units eliminate the devices ability to roll downhill while in use on the horizontal of a gradient. Without the growth units, at maximum fluid capacity, gravity pushes the fluid downhill, which in turn will roll the capsule and dislocate the device. By sealing the top of the device to the bottom, the shape of the capsule has changed and cannot form an oval or circle when filled to capacity, making the present invention much less vulnerable to the variables needed to dislodge on a slope or hill presentation. When used on a slope at maximum fluid capacity, gravity still exerts it's force on the fluid, however the capsule is prevented from rolling because the growth unit seal holds the top to the bottom of the device down the center line, preventing dislocation.

Alternatively, the present invention can be rolled up and stored. By opening the fill valve, to release the internal water, and rolling from the opposing end, remaining water will be pushed out. The device rolls up into a size convenient for carrying and storage at the end of the growing season.

These and other features are advantages of the present invention, and will become apparent to those skilled in the art upon a reading of the following detailed description when taken in conjunction with the drawings wherein there is shown and described illustrative embodiments of the invention.

### BRIEF DESCRIPTION OF THE DRAWINGS

FIG. 1 shows a perspective view with a plurality of growth units extending to the unrolled remainder of the device. The device is empty of any fluid.

FIG. 2 shows a right side elevation view of the unfilled invention length.

FIG. 3 shows a front side elevation view of the unfilled invention width.

FIG. 4 shows a perspective view with a plurality of growth units extending to the fully unrolled remainder of the device. The device is filled with fluid. The growth units are in use with plants/crops planted in the void.

FIG. 5 shows a front side elevation view of the fluid filled invention width. A growth unit is in use with a plant/crop planted in the void.

FIG. 6 shows a bottom plan view of the with a plurality of growth units extending to the unrolled remainder of the device. The invention is empty of any fluid.

FIG. 7 shows a cross section of a growth unit while in use and fluid filled.

FIG. 8 shows a perspective view with a plurality of growth units extending to the implied continuation of the device length. The device is empty of any fluid. The growth units are arranged in a randomly throughout the unit.

FIG. 9 shows a perspective view with a plurality of growth units extending to the implied continuation of the device length. The device is empty of any fluid. The growth units are arranged in a rectangular shape.

FIG. 10 shows a perspective view with a plurality of growth units extending to the implied continuation of the device length. The device is empty of any fluid. The growth units are in a round shape with the open void or split continuing to the edge of the invention.

### DETAILED DESCRIPTION OF THE INVENTION

The basic idea of the thermally protective weed barrier in protecting plants enclosed by the barrier is to prevent competitive plant growth and increase temperatures surrounding the plants. Maximum thermal protection will be reached by filling the device to maximum capacity. The increased mass increases the potential thermal energy. This may prove to be beneficial in early spring or late fall, during periods of colder weather or when frost is eminent. However, maximum thermal protection may not be need during periods of warm weather. Since the amount of thermal energy is dependent upon the amount of fluid contained in the apparatus, the valve can be opened and fluid drained out to reach the desired amount of protection needed. The varying amount of thermal protection does not impact the viability of weed suppression.

Referring to the drawings, a first embodiment of the invention is shown in FIG. 1, showing a self-supporting, thermally protective weed barrier, being generally designated 1. The first embodiment of the present invention 1, includes a single hollow sleeve 2. The material used is a waterproof, flexible, and UV protected sturdy plastic. The material is lightweight yet sturdy, capable of withstanding many years outdoors. The opposing ends of the tube have been sealed top to bottom 3, creating a fluid tight capsule 2, capable of holding a quantity of fluid within. The seals are designed to withstand the pressure created by filling the capsule to maximum capacity.

Multiple holes have been created along the length of the capsule, these are referred to as “growth units” 5. The outer perimeters of the growth units 5, have been sealed 4, top to the bottom to preserve the integrity of the capsule. These seals are water tight and will hold there seal under the pressure created by the fluid within the capsule. The growth units 5 include a void 6, a tangible area to access the underlying soil through the protective capsule. The growth units allow for crops and plants to be placed in the soil. The present invention's novel idea of growth units, envelope each plant or crop with 360 degrees of thermal protection and weed suppression with the use of a singular device.

A valve is present on the capsule 7 to facilitate the filling and draining of fluid from the capsule. Present in FIG. 1 is a rolled portion of the present invention 8. The present invention does not require complete unrolling to be used. By unrolling the device to the desired length of the garden, and leaving the rolled remainder in place, the device can accommodate any sized garden plot or row without cutting or the need for other accessories. This allows the use of desired lengths of the device, while the unused portion is neatly stored without limiting the productivity of the portion of the device in use. The ability to roll up the apparatus makes for easy storage and convenient transport.

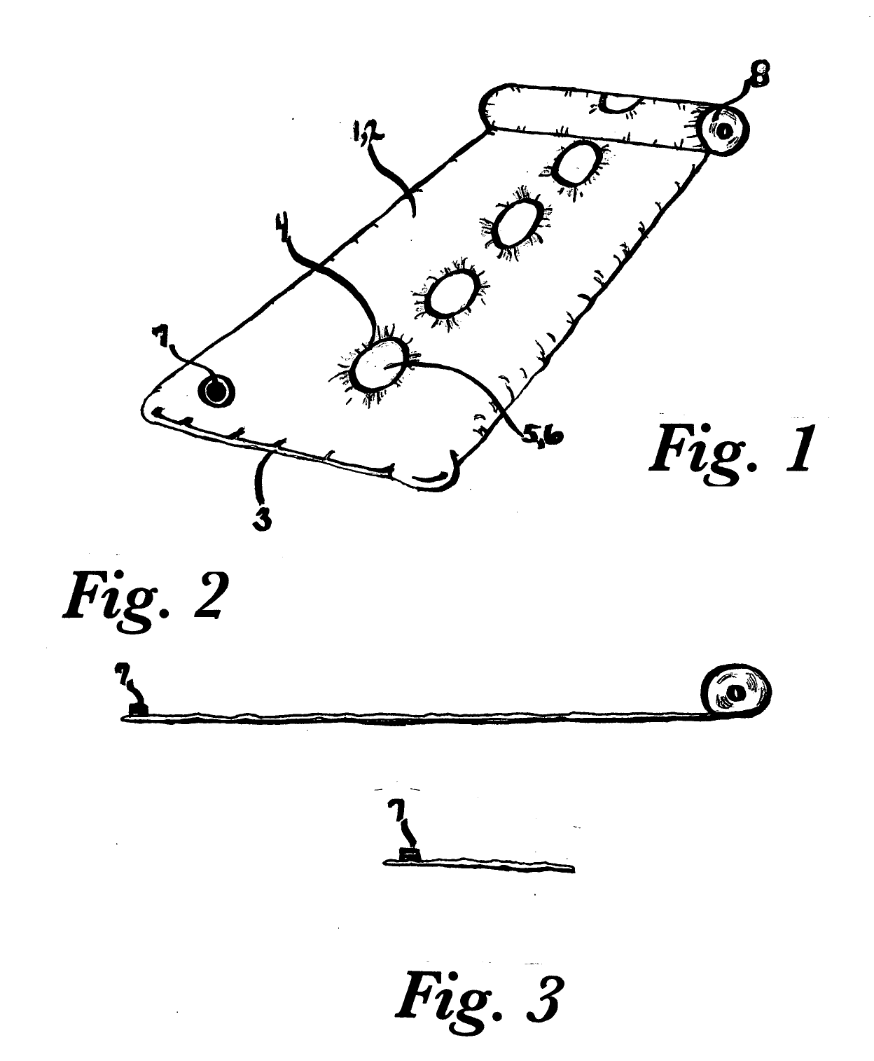

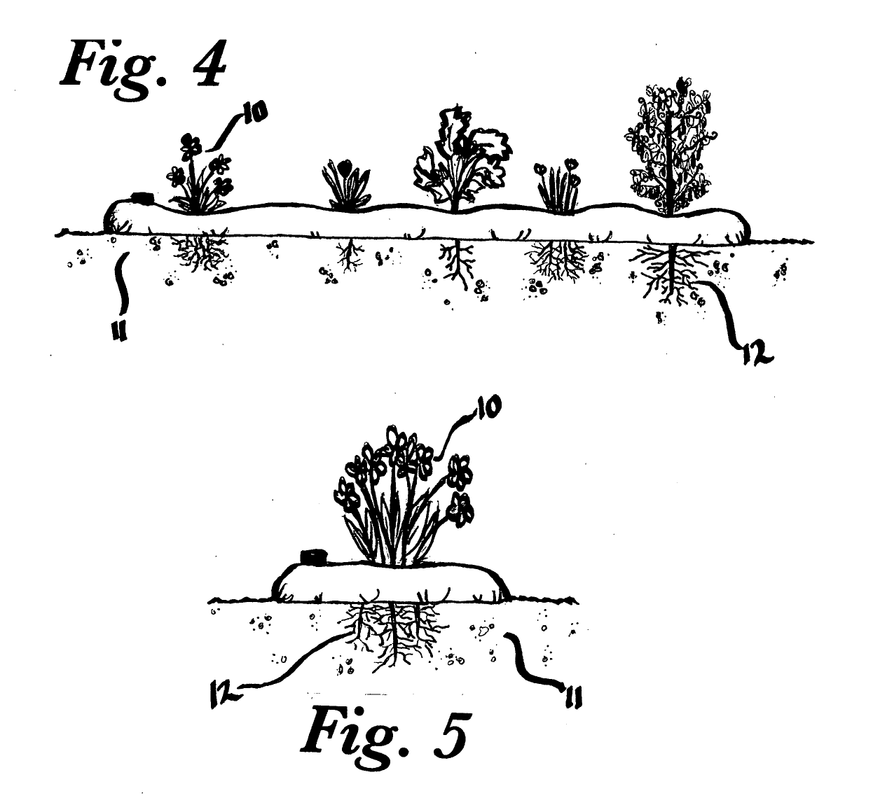

The device has a very low profile as shown in FIG. 2 and FIG. 3. The valve 7 is very prominent before fluid is added. The valve is currently made of a hard plastic mold, however different valve designs may be used. FIG. 2 and FIG. 3 emphasize the sleek and simple design of the present invention 1. The unused roll 8 is neatly stored at the end of the device.

By unrolling the device in a desirable location, the growth units 5 are ready to be planted with plants or crops. The soil should be prepared to the desired depths, soil amendments added, and the plants or crops 10 to be planted in their predetermined growth units 5, as shown in FIG. 4 and FIG. 5. These embodiments show the plants or crops 10, in a fully operational embodiment, the capsule is filled to maximum capacity, with their roots 12 extending through the growth units 5 and into the soil 11 underneath. The fluid filled capsule 1 insulates the roots 12 from evaporation by the sun, heat, and wind while suppressing unwanted plant growth. This also offers ideal habitat and promotes growth of earth worms, another benefit to root systems. The present invention also offers a horizontal 360 degrees of thermal protection to the above ground plant or crop 10 base. The raised elevation of the embodiment helps to protect young and small plants from damage and stunting caused by high winds. This embodiment shows the distances of material between plants or crops 10. This covering greatly decreases the potential for soil to come in contact with the plant or crop leaves and fruit during watering or rain, by means of pooling and splashing. This is a know means of vegetative disease transmission and insect infestation. The plants and crops 10 are cleaner than those grown in an unprotected environment.

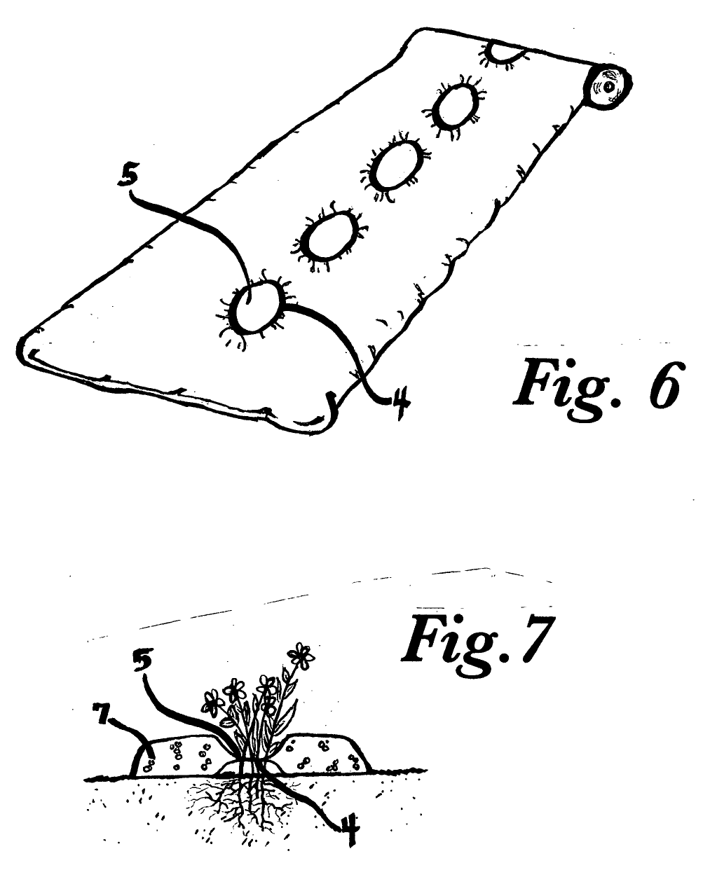

The top and bottom views of the embodiment 1 are identical, understanding that the fill valve is located on the top for easier filling and draining access. FIG. 6 shows the similarities between the top and bottom. Growth units 5 are present along with the end seals.

The embodiment in FIG. 7 shows a cut away cross section of growth unit 5 in use and fluid filled 7. The crop or plant should be centered in the growth unit 5. The growth unit seal 6 is impermeable to water and capable to holding pressure.

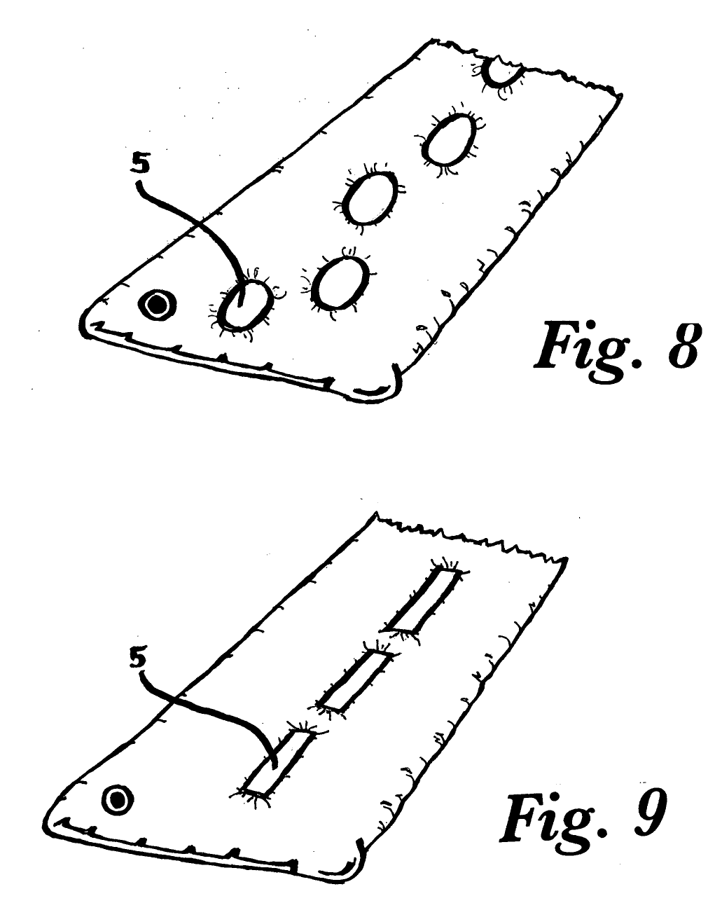

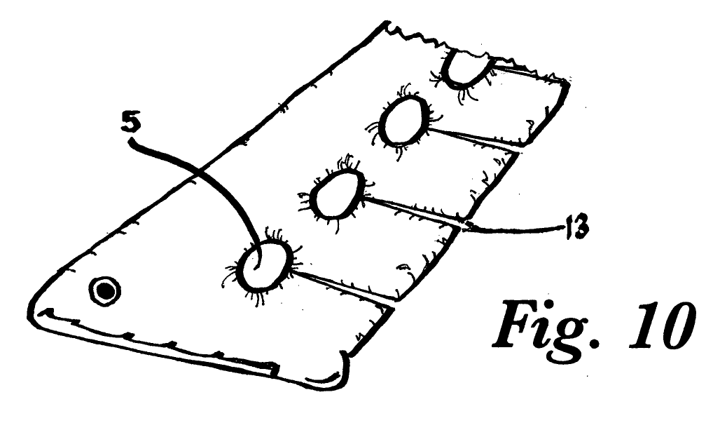

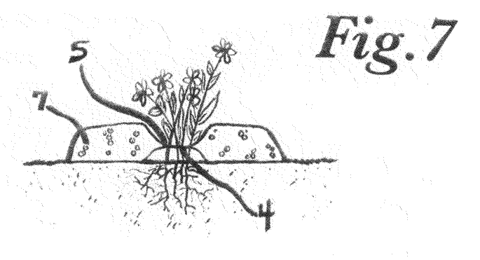

Many variants may be introduced to the thermally protective weed barrier without departing from the scope of this invention. One can envision a series of rectangular, oval, triangular, or many other shaped growth units in a straight, diagonal, or patchwork pattern. As seen in FIG. 8, FIG. 9, and FIG. 10. These embodiments detail some of the different designs and patterns that may be applied to the present invention. In FIG. 8, the present invention 1 is complemented with growth units 5 in a diagonal or random arrangement. In FIG. 9 long narrow rectangular growth units 5 are incorporated. This pattern is specifically for plants of crops that grow in close proximity to each other. Examples would be potatoes, carrots and lettuce. FIG. 10 details a growth unit 5 which is designed for plants that require live removal for replanting. The growth unit 5 is designed in the same manner and specifications as previously discussed. Two additional welds and split 13 has been added. The material has been sealed twice, with the seams extending parallel to each other from the central growth unit 5 to one of the outer edges of the capsule 2. This seams are water impregnable and capable of withstanding the pressure from the water held in the capsule. A cut has been made that extend from the central growth 5 unit to one of the outer edges of the capsule 2. This split opens the growth unit 5 to area not contained within the growth unit 5. This novel approach allows the embodiment to be removed from around the plant or crop when live removal by larger scale digging action is required. This design may also be used when implementation of the devise is needed on a preexisting crop of plant row.

While the invention has been described in the best mode known, the invention is not to be limited to those embodiments shown but is to be governed by the scope of the appended claims and equivalents thereof.

Variations of the garden waterbed are as follows: 1) The UV protected material used can be made in a number of thicknesses and color variations. Other types material may be used in place of the present material; 2) The width, depth, and length of the present invention may vary; 3) The growth units may be arranged in any pattern, shape, or size; 4) Different techniques may be used to create the seals in the material; and/or 5) Any variation of valves may be used to facilitate filling and draining.

We claim:

1. A plant protection device, comprising:
an inflatable tube that provides thermal and barrier protection to plants; and,
wherein the inflatable tube has a plurality of holes that provide protection to a plurality of planets growing through the plurality of holes.

2. The device of claim 1, wherein the holes are spaced evenly apart.

3. device of claim 1, wherein the holes are circular.

4. The device of claim 1, wherein the holes are rectangular.

5. The device of claim 1, wherein the holes are ovular.

6. The device of claim 1, wherein the holes are triangular.

7. The device of claim 1, wherein the holes are square.

8. The device of claim 1, wherein the inflatable tube is filled with water.

9. The device of claim 1, wherein the inflatable tube is made with polyethylene.

10. The device of claim 1, further comprising a filling apparatus.

11. The device of claim 1, wherein the inflatable tube is sealed at each end without being elevated.

12. A means for plant protection comprising:
a means for providing thermal and barrier protection to plants.
The means for plant protection of claim 11, further comprising:
means for filling an inflatable tube.

13. The means for plant protection of claim 11, further comprising:
means for draining an inflatable tube through a valve.

14. A method for plant protection, the method comprising:
laying an inflatable tube on a surface; and
growing plants in the surface through holes in the inflatable tube.

15. The method of claim 15, further including:
filling the inflatable tube does not require elevating each end of the inflatable tube.
